(19) United States
(12) Patent Application Publication
(10) Pub. No.: US 2006/0231188 A1
(43) Pub. Date: Oct. 19, 2006

(54) Method for making artificial suede

(76) Inventor: Han Chao Wen, Taipei Hsien (TW)

Correspondence Address: CHARLES E. BAXLEY, ESQ., 90 JOHN STREET, THIRD FLOOR, NEW YORK, NY, 10038, US

(21) Appl. No.: 11/005,900

(22) Filed: Dec. 7, 2004

(51) Int. Cl. B32B 5/00

(52) U.S. Cl. 156/72; 156/61

(57) ABSTRACT

A method for making artificial suede-like leather product includes preparing a basic sheet member, applying an adhesive material onto the basic sheet member, applying flocks onto the adhesive material, and applying an electric energy onto the flocks, to erect and to implant the flocks on the adhesive material and the basic sheet member, and to form the artificial leather product. An outer covering material may then be applied onto the flocks and the adhesive material, and disposed between the flocks, and to have root portions of the flocks engaged within the outer covering material, and to have the flocks solidly secured to the adhesive material with the outer covering material.

### BACKGROUND OF THE INVENTION

1. Field of the Invention

The present invention relates to a method, and more particularly to a method for easily and quickly making synthetic or artificial suede-like leather products, such as nubuck suede, nulock suede, or the like.

2. Description of the Prior Art

Natural suede or leather materials have become rare due to greatly decreased number of wild animals, and have now been primarily made of leather materials from breeding cattle or animals. However, normally, the natural suede or leather materials may not be made to the required sizes or areas due to the limited sizes or surface areas of the cattle or animals. In addition, the natural suede or leather materials may not be made in mass production due to the limited number of breeding cattle or animals.

Synthetic or artificial leather products have been developed and widely used today, and are primarily made of synthetic or plastic sheet materials having outer surfaces heated or painted or printed with leather-like shapes or patterns thereon, or coated with a buffed coating having exposed cells to produce an artificial suede finish.

For example, U.S. Pat. No. 3,949,123 to Steel discloses one of the typical methods for making coated fabric having suede-like surface formed thereon, and comprising a cellular blend or polyvinyl chloride resin and butadiene-acrylonitrile rubber that is vulcanized and buffed to expose the cells, and thereby produce an artificial suede finish. However, such typical synthetic or artificial leather products have no hairy outer surfaces.

U.S. Pat. No. 4,434,205 to Fujii et al. discloses another typical method for making synthetic or artificial leather products made by impregnating a special nonwoven web substrate with an elastic polymer material, which may have a surface defined by a densely raised mass of fluff resembling fine soft hair, or which may be formed as a grained artificial leather formed by very fine three dimensionally intertwined single fibers. However, it will be difficult to attach the fibers onto the outer surfaces of such typical synthetic or artificial leather products.

The present invention has arisen to mitigate and/or obviate the afore-described disadvantages of the conventional methods for making synthetic or artificial leather products.

### SUMMARY OF THE INVENTION

The primary objective of the present invention is to provide a method for easily and quickly making synthetic or artificial suede-like leather products, such as nubuck suede, nulock suede, or the like.

In accordance with one aspect of the invention, there is provided a method for making artificial suede-like leather product, the method comprising preparing a basic sheet member, applying an adhesive material onto the basic sheet member, applying flocks onto the adhesive material, and applying an electric energy onto the flocks, to erect and to implant the flocks on the adhesive material and the basic sheet member, and to form the artificial leather product.

An outer covering material may then be applied onto the flocks and the adhesive material, to have the outer covering material filled and disposed between the flocks, and to have root portions of the flocks engaged within the outer covering material, and to have the flocks solidly secured to the adhesive material with the outer covering material. The outer covering material and the flocks and the adhesive material may then be heated to cure the outer covering material.

The flocks may then be ground to form fine flocks. The flocks and the adhesive material may then be heated, after applying the electric energy onto the flocks, to cure the adhesive material, and for forming hairy elements.

The fiber materials may be cut into the flocks of small segments having a length ranging from 0.3 to 0.8 mm. The flocks may be treated with chemical activation to have the flocks become electrically conductive materials.

The synthetic or artificial suede-like leather products, such as nubuck suede, nulock suede, or the like made by the method may have better improvements or characteristics, such as color fastness in light, washing, rubbing performs, etc., that are much better than that of the natural suede or leather products. The synthetic or artificial suede-like leather products may be used for making shoes, handbags, leather hats, suitcases, leather belts, gloves, garments, jewel cases, packing materials of cosmetics or gifts, etc.

In addition, the synthetic or artificial suede-like leather products may be made with lower cost, with less wastage during manufacturing processes, and may be made to any required sizes or areas, and may be easily obtained or manufactured without killing or decreasing number of wild animals. Furthermore, the flocks of the synthetic or artificial suede-like leather products may be solidly attached to the basic sheet member, without being disengaged from the basic sheet member, and may thus be greatly improved than the other flocking products.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a synthetic or artificial suede-like leather product to be made with a method in accordance with the present invention;

FIG. 2 is a cross sectional view of the synthetic or artificial suede-like leather product, taken along lines 2-2 of FIG. 1; and

FIG. 3 is a flow chart illustrating the operation of the method in accordance with the present invention for making a synthetic or artificial suede-like leather product.

### DETAILED DESCRIPTION OF THE PREFERRED EMBODIMENT

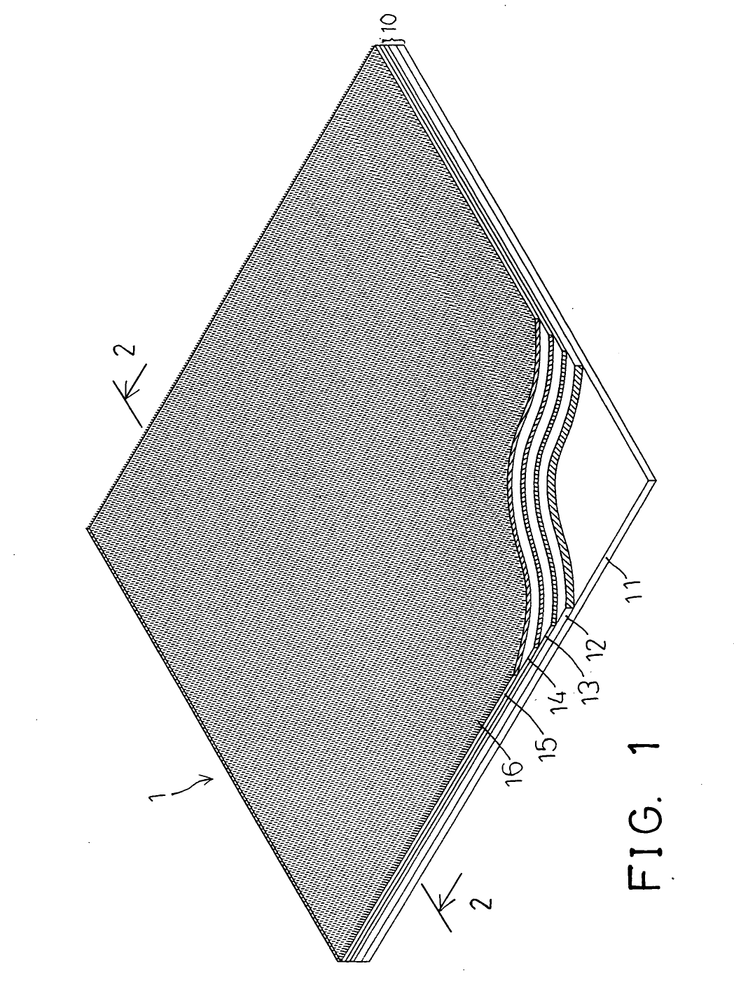

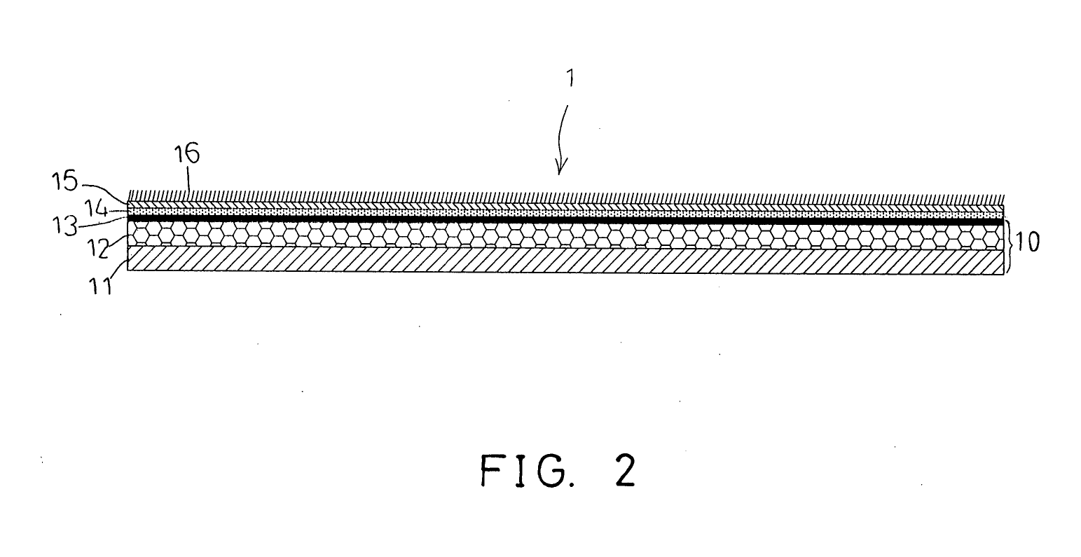

Referring to the drawings, and initially to FIGS. 1 and 2, a method in accordance with the present invention is provided for making a synthetic or artificial suede-like leather product 1 comprising a basic sheet member 10 which includes a cloth layer 11, a foamable layer 12, and a surface layer 13 superposed with each other and secured together to form the basic sheet member 10.

For example, the cloth layer 11 may be made of or may be selected from polyester/cotton blended woven cloth, polyester/rayon blended woven cloth, nylon taffeta woven cloth, polyester pongee woven cloth, non-woven cloth, flannel cloth, or other woven or non-woven cloth members.

The foamable layer 12 may be made of poly urethane (PU) or polyvinyl chloride (PVC) leather materials, or PVC spongy leather materials, or the like. The surface layer 13 may also be made of PVC leather materials, or PVC spongy leather materials, or PU leather materials, or the like. The cloth layer 11 and the foamable layer 12 and the surface layer 13 of the basic sheet member 10 may also be replaced by paper sheets or materials.

An adhesive material 14 is applied onto the surface layer 13 of the basic sheet member 10, and may include PVC paste resin of about 50% by weight, dioctyl phthalate (DOP) of about 48.5% by weight, and stabilizers for PVC materials or PU foamable materials of about 1.5% by weight.

An outer covering material 15 is attached onto and secured to the surface layer 13 of the basic sheet member 10 with the adhesive material 14, and may include PVC paste resin of about 48% by weight, DOP of about 50% by weight, stabilizers for PVC materials of about 1% by weight, and pigment materials of suitable colors or PU materials of about 1% by weight.

A flock material or layer 16 is further provided and applied or attached or disposed onto the outer covering material 15, and may be made of polyester fiber materials. For example, the polyester fiber materials are cut into small segments or flocks 16 having a length ranging from 0.3 to 0.8 mm, and are then subjected or treated with chemical activation or the like, to make or to form the fiber materials or flocks 16 into electrically conductive or semi-electrically conductive materials having an electrically conductivity ranging from 2 to 6×10^{6 Ω.}

It is to be noted that the basic sheet member 10 is preferably made of or selected from the cloth materials that may be subjected with electrostatic flocking processes. For example, the above-described cloth layer 11, such as polyester/cotton blended woven cloth, polyester/rayon blended woven cloth, nylon taffeta woven cloth, polyester pongee woven cloth, non-woven cloth, flannel cloth, or other woven or non-woven cloth members, and the foamable layer 12 and the surface layer 13 of PVC or PU leather materials, or the paper sheets or materials are good for electrostatic flocking processes.

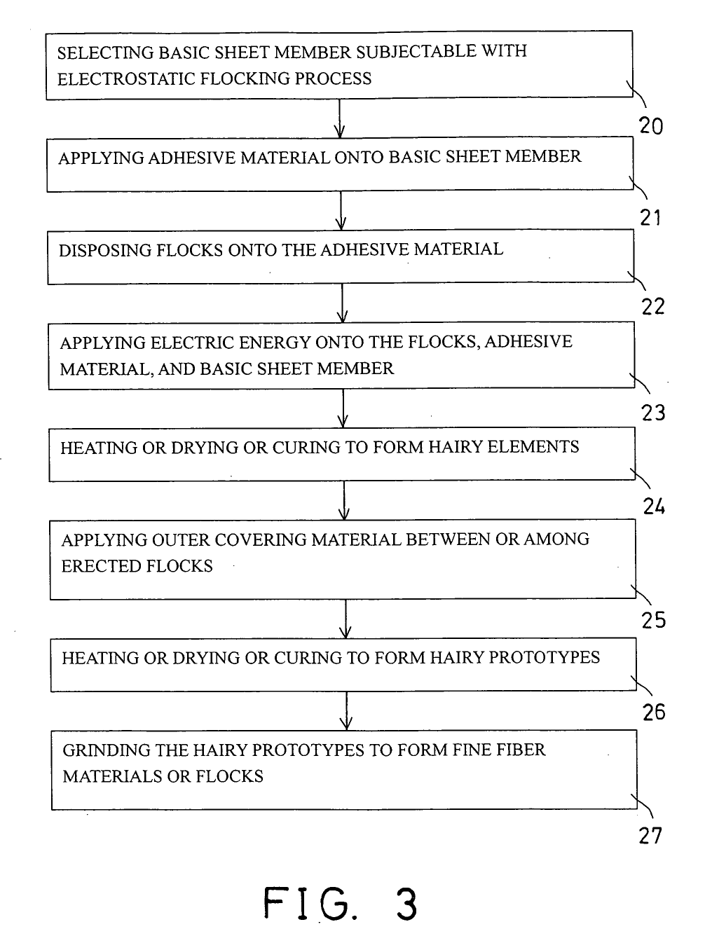

As shown in FIG. 3, the method in accordance with the present invention is thus first required to select or to prepare the basic sheet member 10 that may be subjected with electrostatic flocking processes, in process 20. The adhesive material 14 is then applied onto the basic sheet member 10, in process 21, with such as reverse coating machine, knife coating machine, rotary screen coating machine, gravure coating machine, or other coating machines. The fiber materials or flocks 16 are then applied or disposed onto the adhesive material 14, in process 22.

An electric energy, such as a high voltage direct current of about 50 kV to 60 kV is then applied onto the fiber materials or flocks 16, the adhesive material 14, and the basic sheet member 10, in process 23, to erect and/or to implant the fiber materials or flocks 16 on the adhesive material 14 and the basic sheet member 10, in order to resemble hairy leather products, which are then heated to a temperature ranging from 140 to 170° C., in process 24, for drying or curing the adhesive material 14, and for forming hairy elements.

The outer covering material 15 is then filled or applied onto the fiber materials or flocks 16 and the adhesive material 14 of the hairy elements with such as the above-described coating machines, in process 25, to have the outer covering material 15 filled or disposed between or among the fiber materials or flocks 16, and secured or adhered to the adhesive material 14, and thus to have the root portions of the fiber materials or flocks 16 engaged within the outer covering material 15, and thus to allow the fiber materials or flocks 16 to be solidly secured or adhered to the adhesive material 14 with the outer covering material 15.

The hairy elements having the outer covering material 15 engaged therein are then heated to a temperature ranging from 140 to 190° C., in process 26, for drying or curing purposes, and for forming hairy prototypes. The hairy prototypes are then grounded in 180-200 Mg/s with such as grinding machines of about 100-180 meshes, in process 27.

The fiber materials or flocks 16 may be made or formed into a size or outer diameter of about three (3) deniers, and may then be grounded into fine fibers of about 0.18 deniers, for allowing the fiber materials or flocks 16 to be comfortably touched by the users or people, and thus to form the synthetic or artificial suede-like leather products, that may resemble such as nubuck suede, nulock suede, or the like.

It is to be noted that the fiber materials or flocks 16 may be applied the adhesive material 14 and secured onto the basic sheet member 10 with the adhesive material 14, and may be quickly erected or implanted on the adhesive material 14 by the high voltage direct current electric energy, to resemble hairy leather products, without manpower.

In addition, the outer covering material 15 may then be filled or applied onto the fiber materials or flocks 16 and the adhesive material 14, and filled or disposed between or among the fiber materials or flocks 16, and secured or adhered to the adhesive material 14, to have the root portions of the fiber materials or flocks 16 engaged within the outer covering material 15, and thus to allow the fiber materials or flocks 16 to be solidly secured or adhered to the adhesive material 14 with the outer covering material 15, such that the fiber materials or flocks 16 will be solidly secured onto the basic sheet member 10 and will not be disengaged from the basic sheet member 10.

The synthetic or artificial suede-like leather products, such as nubuck suede, nulock suede, or the like made by the method in accordance with the present invention may have many improvements or characteristics, such as color fastness in light, washing, rubbing performs, etc., that are much better than that of the natural suede or leather products. The synthetic or artificial suede-like leather products may be used for making shoes, handbags, leather hats, suitcases, leather belts, gloves, garments, jewel cases, packing materials of cosmetics or gifts, etc.

In addition, the synthetic or artificial suede-like leather products may be made with lower cost, with less wastage during manufacturing processes, and may be made to any required sizes or areas, and may be easily obtained or manufactured without killing or decreasing number of wild animals. Furthermore, the flocks of the synthetic or artificial suede-like leather products may be solidly attached to the basic sheet member, without being disengaged from the basic sheet member, and may thus be greatly improved than the other flocking products.

Accordingly, the method in accordance with the present invention may be provided for easily and quickly making synthetic or artificial suede-like leather products, such as nubuck suede, nulock suede, or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for making artificial suede-like leather product, said method comprising:
preparing a basic sheet member,
applying an adhesive material onto said basic sheet member,
applying flocks onto said adhesive material, and
applying an electric energy onto said flocks, to erect and to implant said flocks on said adhesive material and said basic sheet member, and to form the artificial leather product.

2. The method as claimed in claim 1 further comprising applying an outer covering material onto said flocks and said adhesive material, to have said outer covering material filled and disposed between said flocks, and to have root portions of said flocks engaged within said outer covering material, and to have said flocks solidly secured to said adhesive material with said outer covering material.

3. The method as claimed in claim 2 further comprising heating said outer covering material and said flocks and said adhesive material, to cure said outer covering material.

4. The method as claimed in claim 1 further comprising grinding said flocks to form fine flocks.

5. The method as claimed in claim 1 further comprising heating said flocks and said adhesive material, after applying the electric energy onto said flocks, to cure said adhesive material, and for forming hairy elements.

6. The method as claimed in claim 1 further comprising cutting fiber materials into said flocks of small segments having a length ranging from 0.3 to 0.8 mm.

7. The method as claimed in claim 1, wherein said flocks are treated with chemical activation to have said flocks become electrically conductive materials.
